(19) United States
(12) Patent Application Publication
(10) Pub. No.: US 2011/0287975 A1
(43) Pub. Date: Nov. 24, 2011

(54) Methods and Compositions for Correlating Genetic Markers with Conversion of Medium Chain Polyunsaturated Fatty Acids to Long Chain Polyunsaturated Fatty Acids

(75) Inventors: Floyd H. Chilton, Clemmons, NC (US); Rasika A. Mathias, Ellicott City, MD (US)

(73) Assignees: The Johns Hopkins University; Wake Forest University Health Sciences

(21) Appl. No.: 13/107,261

(22) Filed: May 13, 2011

Related U.S. Application Data
(60) Provisional application No. 61/334,687, filed on May 14, 2010.

(51) Int. Cl. C40B 30/10

(52) U.S. Cl. 506/12

(57) ABSTRACT

The present invention provides methods of identifying a subject having an increased or decreased ability to convert medium chain-polyunsaturated fatty acids (MC-PUFAs) to long chain polyunsaturated fatty acids (LC-PUFAs), comprising: (a) correlating the presence of one or more than one genetic marker in chromosome 11ql2-13, between build 37.1 position 61548559 and build 37.1 position 61560261, with an increased ability to convert MC-PUFAs to LC-PUFAs; and b) detecting the one or more than one genetic marker of step (a) in the subject, thereby identifying the subject as having an increased ability to convert MC-PUFAs to LC-PUFAs. Also provided are methods of correlating one or more genetic markers with an ability to convert MC-PUFAs to LC-PUFAs.

### STATEMENT OF GOVERNMENT SUPPORT

The present invention was made, in part, with the support of grant numbers P50 AT002782, R01 H1637348, R01 NS058700, F32DK083214, R01 HL087698, from the National Institutes of Health. The United States Government has certain rights to this invention.

### FIELD OF THE INVENTION

The present invention provides methods and compositions directed to identification of genetic markers in chromosome 11 and their correlation with increased conversion of medium chain polyunsaturated fatty acids to long chain polyunsaturated fatty acids.

### BACKGROUND OF THE INVENTION

A primary nutritional requirement for early hominids was the capacity to obtain sufficient long chain polyunsaturated fatty acids (LC-PUFAs), arachidonic acid (AA) and docosahexaenoic acid (DHA), necessary for brain development and growth and immune function. The composition of long-chain polyunsaturated fatty acid (LC-PUFA) in neural and immune cell membranes is a key factor impacting brain development/function and immunity/inflammation. The omega-3 LC-PUFA, docosahexaenoic acid (DHA) plays a critical role in neurogenesis as evidenced by studies showing that dietary DHA is associated with visual and neural development in infants and children (1) and attenuation of cognitive loss in older adults (2). The brain dry matter is about 60% lipid, and DHA is the most abundant omega-3 fatty acid in the brain and retina, constituting 50% of the weight of the neuron's plasma membrane. The omega-6 LC-PUFA, arachidonic acid (AA), is also a major LC-PUFA found in the brain and its metabolic products are crucial to orchestrating immunity and inflammation. Specifically, AA impacts normal and patho-physiologic responses through a variety of mechanisms including its capacity to be converted to potent bioactive products (such as prostaglandins, thromboxanes, leukotrienes and lipoxins), to regulate cellular receptors, or to modulate the expression of genes that control immune responses. In humans, AA constitutes 5-10% of the total fatty acids within inflammatory and neural cellular lipids.

Dietary sources (nuts, seed oils, leafy green vegetables) of medium chain (MC) omega-6 (linoleic acid, LA) and omega-3 (alpha-linolenic acid, ALA) PUFAs provide the essential nutrients that can be converted to LC-PUFAs such as AA, eicosapentaenoic acid (EPA) and docosapentaenoic acid (DPA), by the alternate actions of FA desaturase (FADS) and elongase enzymes that introduce carbon-carbon double bonds and increase chain length by 2 carbons, respectively (FIG. 1, center pathway). DHA is then thought to be formed from DPA utilizing an additional elongation step followed by desaturation and then chain shortening. However, studies to date indicate that only a small proportion of dietary LA is converted to AA and only trace amounts ALA are eventually found as DHA in humans (3,4). These data suggest that sufficient AA and DHA probably cannot be synthesized solely from this pathway to maintain a steady state, considering their high rates of usage as key membrane components, cellular signals and substrates for oxidation (5). However, modern omnivore diets provide preformed LC-PUFAs from animal products (AA: organ and muscle meats, egg yolk; EPA and DHA: fish, shellfish), which offset the need for endogenously-synthesized LC-PUFAs.

Three members of the FADS gene family, localized to chromosome 11q12-13, are involved in the conversion of MC-PUFAs to LC-PUFAs. Speculated to have arisen during human evolution by gene duplication, FADS1-3 have a high degree of sequence identity (62-70%), almost identical intron/exon organization (6) and appear to be highly conserved between species (see Table 1). There has been a number of studies in populations that are European, Asian or of European descent on the effects of genetic variants in FADS1 and FADS2 in PUFA metabolism with little evidence for genetic loci outside of 11q12-13 (7). To date the most strongly associated variant is single nucleotide polymorphism (SNP) rs174537 (p=5.95×10⁻⁴⁶, (8)), which maps to open reading frame c11orf9 upstream of FADS1 and accounts for ˜19% the phenotypic variation in AA. The location of the precise genetic locus that accounts for this association signal is difficult to predict because all these studies document high levels of linkage disequilibrium (LD) and associations with increased AA levels over multiple SNPs with an LD block that encompasses all of FADS1 and half of FADS2.

TABLE 1
Conservation of FADS gene cluster presented as percentage homology for protein
and DNA between humans and other species as reported in Homologene
(www.ncbi.nlm.nih.gov/homologene) revealing considerable conservation in range of species
including chicken for FADS1(~737%) and FADS2 (~75%), and zebra fish for FADS2
(~65%).

| | | FADS1 | | FADS2 | | FADS3 | |
|---|---|---|---|---|---|---|---|
| Homo sapien vs. | human vs. | Protein | DNA | Protein | DNA | Protein | DNA |
| Pan troglodytes | chimpanzee | 99.8 | 99.8 | 99.8 | 99.8 | 99.8 | 99.7 |
| Canis lupus familiaris | dog | 90.8 | 91.5 | 89.8 | 90.7 | 86.4 | 87.2 |
| Bos taurus | cattle | 88.2 | 86.6 | 89.6 | 89.6 | 88.5 | 89.1 |
| Mus musculus | mouse | 89 | 85.9 | 87.6 | 87.2 | 90.1 | 87.9 |
| Rattus norvegicus | rat | 88.5 | 86 | 88.3 | 87.3 | 89.9 | 87.8 |
| Gallus gallus | red jungle | 73.2 | 72.4 | 77 | 74.9 | — | — |
| | fowl | | | | | | |
| Danio rerio | zebrafish | — | — | 64.9 | 67.2 | — | — |

Land-based mammals lost relative brain capacity as they evolved to become larger (9). This relative decrease in brain size is postulated to be due to a greater need for LC-PUFAs for brain development than the diet could supply (5). Homo sapiens are anomalous with regard to this principle, as a large and complex brain continued to evolve despite an environment (African savanna, 200 kya) providing an irregular diet. There is intense debate concerning the source of preformed LC-PUFAs in the diet of early modern humans (4,5,9,10).

### SUMMARY OF THE INVENTION

The present inventors have discovered that there appears to have been positive selective pressure for influential genetic variants in the FADS cluster in the absence of dietary sources of LC-PUFAs, which facilitated higher conversion rates of plant-derived ALA and LA to LC-PUFA. This selection may have led to differences in allele frequencies and consequently differences in levels of circulating LC-PUFAs in contemporary populations of African and European decent. Accordingly, the present invention provides methods and compositions for correlating genetic markers in a subject with various aspects of polyunsaturated fatty acid metabolism and dietary regimens that can be adjusted based on the genetic markers identified in a subject.

Thus, in one aspect, the present invention provides a method of identifying a subject having an increased ability to convert medium chain-polyunsaturated fatty acids (MC-PUFAs) to long chain polyunsaturated fatty acids (LC-PUFAs), comprising detecting in the subject one or more than one genetic marker in chromosome 11q12-13, between build 37.1 position 61548559 and build 37.1 position 61560261, correlated with an increased ability to convert MC-PUFAs to LC-PUFAs.

Further provided herein is a method of identifying a subject having a decreased ability to convert MC-PUFAs to LC-PUFAs comprising detecting in the subject the presence of one or more than one genetic marker in chromosome 11q12-13, between build 37.1 position 61548559 and build 37.1 position 61560261, correlated with a decreased ability to convert MC-PUFAs to LC-PUFAs.

Additionally provided is a method of screening a subject for an increased ability to convert MC-PUFAs to LC-PUFAs comprising detecting the presence or absence of one or more than one genetic marker in chromosome 11q12-13, between build 37.1 position 61548559 and build 37.1 position 61560261, correlated with an increased ability to convert MC-PUFAs to LC-PUFAs, wherein the presence of said marker indicates that the subject has an increased ability to convert MC-PUFAs to LC-PUFAs.

Furthermore, the present invention provides a method of screening a subject for a decreased ability to convert MC-PUFAs to LC-PUFAs comprising: detecting the presence or absence of one or more than one genetic marker in chromosome 11q12-13, between build 37.1 position 61548559 and build 37.1 position 61560261, correlated with a decreased ability to convert MC-PUFAs to LC-PUFAs, wherein the presence of said marker indicates that the subject has a decreased ability to convert MC-PUFAs to LC-PUFAs.

In yet further aspects, the present invention provides a method of correlating a genetic marker with an increased ability to convert MC-PUFAs to LC-PUFAs, comprising: a) detecting in a population of subjects with an increased ability to convert MC-PUFAs to LC-PUFAs the presence of one or more genetic markers in chromosome 11q12-13, between build 37.1 position 61548559 and build 37.1 position 61560261; and b) correlating the presence of the one or more genetic markers of step (a) with an increased ability to convert MC-PUFA to LC-PUFA.

Further provided herein is a method of correlating a genetic marker with a decreased ability to convert MC-PUFAs to LC-PUFAs, comprising: a) detecting in a population of subjects with a decreased ability to convert MC-PUFAs to LC-PUFAs the presence of one or more genetic markers in chromosome 11q12-13, between build 37.1 position 61548559 and build 37.1 position 61560261; and b) correlating the presence of the one or more genetic markers of step (a) with a decreased ability to convert MC-PUFA to LC-PUFA.

Other aspects of the invention provide a method of identifying a subject for whom a defined dietary regimen would be effective, comprising detecting in the subject one or more than one genetic marker in chromosome 11q12-13, between build 37.1 position 61548559 and build 37.1 position 61560261, correlated with an effective defined dietary regimen for individuals having said one or more genetic markers.

Other and further objects, features and advantages would be apparent and more readily understood by reading the following specification and by reference to the accompanying drawing forming a part thereof, or any examples of the embodiments of the invention given for the purpose of the disclosure.

### BRIEF DESCRIPTION OF THE FIGURES

FIG. 1 shows serum fatty acid distribution of omega-3 (left) and omega-6 (right) PUFAs in African American (A, blue; n=63) and white (W, red; n=166) subjects with diabetes/metabolic syndrome from the DHS. The enzymes of the PUFA synthetic pathway (center) are shared by omega-3 (left) and omega-6 (right) PUFAs. The probability density histograms indicate the distribution of subjects having circulating PUFA concentrations (as a function of percent of total fatty acids). Subjects of African ancestry showed statistically significant differences in ALA, AA and DHA distributions compared to those in white subjects (p values indicated on histograms). Analysis of covariance was used to assess the racial difference in the fatty acids adjusting for sex and age. Residuals were examined to assess the model assumptions (linearity, homogeneity of variances, and normality). Inset: The product/precursor ratios in these subject populations show that differences in circulating PUFA levels are further reflected by highly significant elevations in DHA to ALA, EPA to ALA and AA to LA ratios in individuals of African ancestry.

FIG. 2: Panel A illustrates phased haplotypes in a 100 Kb region of peak XP-EHH scores for the South Asian (top) European (middle) and African (bottom) HDGP populations; rows representing chromosomes and columns representing SNPs (28). Common color indicates identical underlying sequence and reveals low haplotype diversity within each continent (lack of a mosaic pattern) but a key difference in breakdown of the haplotype within Africa that includes six SNPs (rs509360, rs174532, rs174534, rs174537, rs102275 and rs412334). Panel B presents the iHS (top) and XP-EHH (bottom) (29,30) scores along a 1 Mb region centered on rs174737 in population from African (Bantu, black), the Americas (blue), Europe (orange) and southern Asia (green). The data support the hypothesis of positive selective pressure within the African continent. Panel C illustrates the strength of this XP-EHH statistic at rs174537 in an African population (Bantu) showing its relative place (99.9^{th} percentile) in the distribution of the XP-EHH statistic across the entire genome.

FIG. 3 shows the geographic distribution of derived allele frequencies (shown in orange) in a 100 Kb region surrounding rs174537 in the 52 populations represented in the Human Genome Diversity Panel Data illustrating the fixation of derived rs174537 G allele within the African continent. For all previously published associations, the allele associated with increased levels of LC-PUFAs are indicated depicting a consistent increased allele frequency of this specific allele within the African continent compared to Europe and Asia across most loci depicted.

FIG. 4 shows the correlation between the seven SNPs in the FADS gene cluster genotyped in the DHS data showing block structure as defined by the algorithm of Gabriel et al (12) using 33 independent African American (right) and 89 white (left) subjects in the analysis (range of LD from high to low displayed as color ranging from dark red to white, respectively) and pair-wise r² values are presented as numbers. Physical location of the seven SNPs and the gene structure of the FADS gene cluster are shown (dark blue line=physical location of genotyped SNP; light pink small/large boxes=exon/intron structure in FADS genes).

FIG. 5 shows the calculations over two thresholds of significance: FIG. A (top) nominal threshold p=0.05; and FIG. B (bottom) the level of significance observed in the white samples p=10⁻⁶ demonstrating low power to detect the same effect size as observed in the white DHS subjects for allele frequencies noted in the African American DHS individuals. Power was calculated in QUANTO over various sample sizes (N=50−550) using genotypic estimates based on observations for arachadonic acid at rs174537 in the whites (mean=7.89, Std. dev.=2.05, additive effect due to the minor allele at SNP βₐ=−1.1800) over allele frequencies observed in the DHS whites (>30%) and African Americans (<15%). Power is plotted over allele frequency (νₐ) and corresponding heritability due to the locus h²_{G} (a function of additive effects at the locus and allele frequency). To have sufficient power in the African American individuals at allele frequencies<10% we would need to sample 200 subjects for a nominal threshold, but over 550 samples to reach similar levels of significance as observed in the whites.

### DETAILED DESCRIPTION

The present invention is explained in greater detail below. This description is not intended to be a detailed catalog of all the different ways in which the invention may be implemented, or all the features that may be added to the instant invention. For example, features illustrated with respect to one embodiment may be incorporated into other embodiments, and features illustrated with respect to a particular embodiment may be deleted from that embodiment. In addition, numerous variations and additions to the various embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations and variations thereof.

The present invention is based on the unexpected discovery of geographic differences in allelic variants in the FADS gene cluster (more specifically, it points to a 12 kb region of chromosome 11q12-13, between build 37.1 position 61548559 and build 37.1 position 61560261 as comprising the allelic variants), that are associated with increased conversion to long chain polyunsaturated fatty acids, which results in a marked increased in arachidonic and docosahexaenoic acids in individuals of African ancestry. Further, the alternate alleles of the these variants are expected to be associated with decreased conversion to long chain polyunsaturated fatty acids, which results in a decreased circulating and cellular levels of arachidonic and docosahexaenoic acids.

A number of studies point to the impact of PUFAs on inflammation and chronic human disease even when considered at the level of the human genome. Three members of the FA desaturase (FADS) gene family appear to be pivotal in the conversion of medium chain PUFAs to longer chain PUFAs. These desaturases (FADS1, FADS2 and FADS3) are localized to a 1.4 Mb region in chromosome 11q12-q13, and they are speculated to have arisen during human evolution though the mechanism of gene duplication as evidenced by their high degree of sequence identity (62-70%) and almost identical intron/exon organization. The contribution of genetic variants in FADS1 and FADS2 to circulating and cellular levels of PUFAs has been explored in multiple candidate gene studies, which rely on a subset of single nucleotide polymorphisms (SNPs) in this genomic region. However, all of these studies are on populations that are European, Asian or of European descent, and with the extensive linkage disequilibrium (LD) observed in this genomic region, which includes all of FADS1 and much of FADS2, the precise location of the target variants responsible for these associations are difficult to identify. The LD block that includes the SNPs with peak association is as much as 60 kb in length and includes all of FADS1 and a significant portion of FADS2. The work that the present inventors have done on this region in individuals of African ancestry identifies a 12 kb region (⅕^{th} the size of the target region defined above) that appears to explain the association signal seen here, and it is within this region that the target variant appears to reside.

The present inventors show that positive selective pressure for influential genetic variants in the FADS cluster, in the absence of dietary sources of LC-PUFAs, facilitated higher conversion rates of plant-derived ALA and LA to LC-PUFA. This positive selection pressure is believed to have led to differences in allele frequencies resulting in striking differences in the levels of circulating LC-PUFAs in contemporary populations of African and European decent. Thus, marked increases in AA and DHA levels and their ratios to plant-based PUFAs are shown for subjects of African ancestry. These differences correlate with the frequency of alleles in the FADS gene cluster associated with increased conversion to LC-PUFAs. Such observations suggest that variations that were once adaptive may now be maladaptive in humans consuming modern ‘western’ diets, which are already high in omega-6 MC-PUFAs (15-20 g/day, principally LA). Thus, a high capacity to convert MC-PUFAs to LC-PUFAs would promote increased production of inflammatory AA and products of AA.

Thus, in making the association between the ability to convert medium chain PUFAs to long chain PUFAs and the allelic variants in the FADS gene cluster, specifically those in the 12 kb region of chromosome 11q12-13, between build 37.1 position 61548559 and build 37.1 position 61560261, facilitates the development of a test for predicting the risk for developing particular conditions and disorders that are associated with high or low circulating levels and cellular levels of PUFAs.

Accordingly, in one embodiment, the present invention provides a method of identifying a subject having an increased ability to convert medium chain-polyunsaturated fatty acids (MC-PUFAs) to long chain polyunsaturated fatty acids (LC-PUFAs), comprising: detecting in the subject one or more than one genetic marker in chromosome 11q12-13, between build 37.1 position 61548559 and build 37.1 position 61560261, correlated with an increased ability to convert MC-PUFAs to LC-PUFAs.

In an additional embodiment, the present invention provides a method of identifying a subject having an increased ability to convert MC-PUFAs to LC-PUFAs, comprising: a) correlating the presence of one or more than one genetic marker in chromosome 11q12-13, between build 37.1 position 61548559 and build 37.1 position 61560261, with an increased ability to convert MC-PUFAs to LC-PUFAs; and b) detecting the one or more than one genetic marker of step (a) in the subject, thereby identifying the subject as having an increased ability to convert MC-PUFAs to LC-PUFAs.

Further provided herein is a method of identifying a subject having a decreased ability to convert MC-PUFAs to LC-PUFAs comprising: detecting in the subject the presence of one or more than one genetic marker in chromosome 11q12-13, between build 37.1 position 61548559 and build 37.1 position 61560261, correlated with a decreased ability to convert MC-PUFAs to LC-PUFAs.

In yet further aspects, the present invention provides a method of identifying a subject having a decreased ability to convert MC-PUFAs to LC-PUFAs, comprising: a) correlating the presence of one or more than one genetic marker in chromosome 11q12-13, between build 37.1 position 61548559 and build 37.1 position 61560261, with a decreased ability to convert MC-PUFAs to LC-PUFAs; and b) detecting the presence of one or more than one genetic marker of step (a) in the subject, thereby identifying the subject as having a decreased ability to convert MC-PUFAs to LC-PUFAs.

Additionally provided is a method of screening a subject for an increased ability to convert MC-PUFAs to LC-PUFAs comprising: detecting the presence or absence of one or more than one genetic marker in chromosome 11q12-13, between build 37.1 position 61548559 and build 37.1 position 61560261, correlated with an increased ability to convert MC-PUFAs to LC-PUFAs, wherein the presence of said marker indicates that the subject has an increased ability to convert MC-PUFAs to LC-PUFAs.

Furthermore, the present invention provides a method of screening a subject for a decreased ability to convert MC-PUFAs to LC-PUFAs comprising: detecting the presence or absence of one or more than one genetic marker in chromosome 11q12-13, between build 37.1 position 61548559 and build 37.1 position 61560261, correlated with a decreased ability to convert MC-PUFAs to LC-PUFAs, wherein the presence of said marker indicates that the subject has a decreased ability to convert MC-PUFAs to LC-PUFAs.

Also provided herein is a method of screening a subject for an increased ability to convert MC-PUFAs to LC-PUFAs, comprising: a) correlating the presence of one or more than one genetic marker in chromosome 11q12-13, between build 37.1 position 61548559 and build 37.1 position 61560261, with an increased ability to convert MC-PUFAs to LC-PUFAs; and b) detecting the one or more than one genetic marker of step (a) in the subject.

A further aspect of the invention is a method of screening a subject for a decreased ability to convert MC-PUFAs to LC-PUFAs, comprising: a) correlating the presence of one or more than one genetic marker in chromosome 11q12-13, between build 37.1 position 61548559 and build 37.1 position 61560261, with a decreased ability to convert MC-PUFAs to LC-PUFAs; and b) detecting the presence of one or more than one genetic marker of step (a) in the subject.

In yet further aspects, the present invention provides a method of correlating a genetic marker with an increased ability to convert MC-PUFAs to LC-PUFAs, comprising: a) detecting in a population of subjects with an increased ability to convert MC-PUFAs to LC-PUFAs the presence of one or more genetic markers in chromosome 11q12-13, between build 37.1 position 61548559 and build 37.1 position 61560261; and b) correlating the presence of the one or more genetic markers of step (a) with an increased ability to convert MC-PUFA to LC-PUFA.

Further provided herein is a method of correlating a genetic marker with a decreased ability to convert MC-PUFAs to LC-PUFAs, comprising: a) detecting in a population of subjects with a decreased ability to convert MC-PUFAs to LC-PUFAs the presence of one or more genetic markers in chromosome 11q12-13, between build 37.1 position 61548559 and build 37.1 position 61560261; and b) correlating the presence of the one or more genetic markers of step (a) with a decreased ability to convert MC-PUFA to LC-PUFA.

It would be understood that in some embodiments, the methods of this invention can be carried out using a computer database, wherein the data from multiple subjects are stored in a computer database and analyzed according to art-known methods of statistical and mathematical analysis to identify means, medians, trends, statistically significant changes, variances, etc.

Thus the present invention provides a computer-assisted method of identifying an increased or decreased ability to convert MC-PUFAs to LC-PUFAs and correlating the increased or decreased ability to convert MC-PUFAs to LC-PUFAs with the presence of one or more genetic markers in chromosome 11q12-13, between build 37.1 position 61548559 and build 37.1 position 61560261. The method involves the steps of (a) storing a database of biological data for a plurality of subjects, the biological data that is being stored including for each of said plurality of subjects: (i) a description of the status of the subject (i.e., their ability to convert MC-PUFAs to LC-PUFAs), (ii)) a description of measurements of genetic marker(s) in the subject; and then (b) querying the database to determine the relationship/correlation between the presence or absence of the genetic marker(s) in the subject and the subject's ability to convert MC-PUFAs to LC-PUFAs. Such querying can be carried out prospectively or retrospectively on the database by any suitable means, but is generally done by statistical analysis in accordance with known techniques, as described herein.

Other aspects of the invention provide a method of identifying a subject for whom a defined dietary regimen would be effective, comprising: detecting in the subject one or more than one genetic marker in chromosome 11q12-13, between build 37.1 position 61548559 and build 37.1 position 61560261, correlated with an effective defined dietary regimen for individuals having said one or more genetic markers.

Thus, by identifying a subject as having an increased or decreased ability to convert MC-PUFAs) to LC-PUFAs through the detection of one or more genetic markers correlated with increased or decreased ability to convert MC-PUFAs to LC-PUFAs, respectively, a subject can then be provided a defined dietary regimen to treat or prevent the disease/disorder/condition known to be associated with circulating and cellular levels of PUFAs.

The present invention further provides one or more than one genetic marker, wherein the genetic marker is selected from specific alleles at genetic variants within the genomic locations of 61548559 and position 61560261 (Build 37.1) and any combination thereof.

As discussed above, particular diseases, disorders, and/or conditions are known to be associated with high or low circulating levels and cellular levels of PUFAs. As an example, long chain polyunsaturated fatty acids (LC-PUFAs), docosahexaenoic acid (DHA) and arachidonic acid (AA) are indispensible during embryonic and fetal development. During this period of time until the first few months after birth, the brain is most sensitive to a lack of LC-PUFAs. This is particularly the case in the third trimester when the brain is growing most rapidly. Studies to date indicate that normal visual and cognitive development is dependent on an adequate supply of DHA and AA in synapses and photoreceptors and randomized controlled trials demonstrate impaired mental performance (e.g., childhood IQ scores) and visual function (e.g., visual acuity and stereo-acuity) in healthy term infants when dietary DHA and AA are not in the maternal diet. Similarly, animal studies with rhesus monkeys demonstrate that a ω-3 fatty acid deficiency during gestation and postnatal development causes marked psychomotor and cognitive deficits as well as impaired visual function (e.g., visual acuity). Additionally, the lack of ω-3 LC-PUFAs, or an imbalance between ω-3 and ω-6 fatty acids, has been associated with a number of behavioral abnormalities, as well as neurological and psychiatric disorders in both children and adults, particularly attention-deficit hyperactivity (ADHD) and autism spectrum disorders, as well as with unipolar and bipolar disorders.

Thus, in some embodiments of the present invention, the disease, disorders or conditions that have been associated with a lack of ω-3 LC-PUFAs or an imbalance between ω-3 and ω-6 PUFAs include, but are not limited to, attention-deficit hyperactivity, autism, unipolar disorder and bipolar disorder. Thus, by identifying a subject as having an increased or decreased ability to convert MC-PUFAs to LC-PUFAs through the detection of genetic markers (correlated with an increased or decreased ability to convert MC-PUFAs to LC-PUFAs) in a DNA sample from said subject, the subject can be provided with a dietary regimen that can change their levels of circulating and cellular PUFAs, and thus, treat or prevent the disorder that is associated with the lack of ω-3 LC-PUFAs or an imbalance between ω-3 and ω-6 PUFAs.

The present invention further provides methods of identifying a gestating subject having an increased or decreased ability to convert MC-PUFAs to LC-PUFAs by detecting genetic markers (correlated with an increased or decreased ability to convert MC-PUFAs to LC-PUFAs) in a DNA sample from said subject. By identifying the subject as having an increased or decreased ability to convert MC-PUFAs to LC-PUFAs, an appropriate dietary regimen can be provided that can treat or prevent fatty acid deficiencies that result in impaired visual and cognitive development in embryos and fetuses.

Dietary regimens for diseases, disorders, or conditions that are affected by circulating and cellular levels of PUFAs are well known in the art. Thus, non-limiting examples of dietary regimens for the treatment, amelioration, or prevention of diseases, disorders or conditions known to be affected by levels of circulating and cellular PUFAs include autism spectrum disorders, unipolar disorder, bipolar disorder, and attention-deficit disorder.

Subjects who respond well to particular dietary regimens can be analyzed for specific genetic markers and a correlation can be established according to the methods provided herein. Alternatively, subjects who respond poorly to a particular dietary regimen can also be analyzed for particular genetic markers correlated with the poor response. Then, a subject who is a candidate for a particular dietary regimen for adjusting circulating and cellular levels of PUFAs can be assessed for the presence of the appropriate genetic markers and the most effective and/or appropriate dietary regimen can be provided.

In some embodiments, the methods of correlating genetic markers with dietary regimens of this invention can be carried out using a computer database. Thus the present invention provides a computer-assisted method of identifying a proposed dietary regimen for adjusting circulating and cellular levels of PUFAs. The method involves the steps of (a) storing a database of biological data for a plurality of subjects, the biological data that is being stored including for each of said plurality of subjects, for example, (i) a dietary regimen, (ii) at least one genetic marker associated with an increased or decreased ability to convert MC-PUFAs to LC-PUFAs and (iii) at least one disease progression measure from which the efficacy of the dietary regimen can be determined; and then (b) querying the database to determine the dependence on the genetic marker of the effectiveness of the dietary regimen in adjusting the circulating and cellular levels of PUFAs (and thus, treating, ameliorating or preventing a disease, disorder or condition), to thereby identify a proposed dietary regimen as an effective and/or appropriate diet for a subject carrying a genetic marker correlated with increased or decreased ability to convent MC-PUFAs to LC-PUFAs.

In one embodiment, information regarding the dietary regimen provided for a subject is entered into the database (through any suitable means such as a window or text interface), genetic marker information for that subject is entered into the database, and disease progression information is entered into the database. These steps are then repeated until the desired number of subjects has been entered into the database. The database can then be queried to determine whether a particular dietary regimen is effective for subjects carrying a particular marker or combination of markers, not effective for subjects carrying a particular marker or combination of markers, etc. Such querying can be carried out prospectively or retrospectively on the database by any suitable means, but is generally done by statistical analysis in accordance with known techniques, as described herein.

In further aspects, the present invention provides a kit for carrying out the methods of this invention, wherein the kit can comprise primers, probes, primer/probe sets, reagents, buffers, etc., as would be known in the art, for the detection of a mutation within the genomic location between position 61548559 and position 61560261 (Build 37.1) in a nucleic acid sample from the subject. Such a kit can further comprise blocking probes, labeling reagents, blocking agents, restriction enzymes, antibodies (e.g., secondary antibodies), ligands, immunoglobulin binding agents, sampling devices, positive and negative controls, etc., as would be well known to those of ordinary skill in the art.

As used herein, “a,” “an” or “the” can mean one or more than one. For example, “a” cell can mean a single cell or a multiplicity of cells.

Also as used herein, “and/or” refers to and encompasses any and all possible combinations of one or more of the associated listed items, as well as the lack of combinations when interpreted in the alternative (“or”).

Furthermore, the term “about,” as used herein when referring to a measurable value such as an amount of a compound or agent of this invention, dose, time, temperature, and the like, is meant to encompass variations of ±20%, ±10%, ±5%, ±1%, ±0.5%, or even ±0.1% of the specified amount.

The term “chromosome region” as used herein refers to a part of a chromosome defined either by anatomical details, especially by banding, or by its linkage groups. The particular chromosome regions of this invention are further defined by the following boundaries.

Also as used herein, “linked” describes a region of a chromosome that is shared more frequently in family members or members of a population manifesting a particular phenotype and/or affected by a particular disease or disorder, than would be expected or observed by chance, thereby indicating that the gene or genes or other identified marker(s) within the linked chromosome region contain or are associated with an allele that is correlated with the phenotype and/or presence of a disease or disorder, or with an increased or decreased likelihood of the phenotype and/or of the disease or disorder. Once linkage is established, association studies (linkage disequilibrium) can be used to narrow the region of interest or to identify the marker (e.g., allele or haplotype) correlated with the phenotype and/or disease or disorder.

Furthermore, as used herein, the term “linkage disequilibrium” or “LD” refers to the occurrence in a population of two linked alleles at a frequency higher or lower than expected on the basis of the gene frequencies of the individual genes. Thus, linkage disequilibrium describes a situation where alleles occur together more often than can be accounted for by chance, which indicates that the two alleles are physically close on a DNA strand.

The term “genetic marker” or “polymorphism” as used herein refers to a characteristic of a nucleotide sequence (e.g., in a chromosome) that is identifiable due to its variability among different subjects (i.e., the genetic marker or polymorphism can be a single nucleotide polymorphism, a restriction fragment length polymorphism, a microsatellite, a deletion of nucleotides, an addition of nucleotides, a substitution of nucleotides, a repeat or duplication of nucleotides, a translocation of nucleotides, and/or an aberrant or alternate splice site resulting in production of a truncated or extended form of a protein, etc., as would be well known to one of ordinary skill in the art).

A “single nucleotide polymorphism” (SNP) in a nucleotide sequence is a genetic marker that is polymorphic for two (or in some case three or four) alleles. SNPs can be present within a coding sequence of a gene, within noncoding regions of a gene and/or in an intergenic (e.g., intron) region of a gene. A SNP in a coding region in which both forms lead to the same polypeptide sequence is termed synonymous (i.e., a silent mutation) and if a different polypeptide sequence is produced, the alleles of that SNP are non-synonymous. SNPs that are not in protein coding regions can still have effects on gene splicing, transcription factor binding and/or the sequence of non-coding RNA.

The SNP nomenclature provided herein refers to the official Reference SNP (rs) identification number as assigned to each unique SNP by the National Center for Biotechnological Information (NCBI), which is available in the GenBank® database.

In some embodiments, the term genetic marker is also intended to describe a phenotypic effect of an allele or haplotype, including for example, an increased or decreased amount of a messenger RNA, an increased or decreased amount of protein, an increase or decrease in the copy number of a gene, production of a defective protein, tissue or organ, etc., as would be well known to one of ordinary skill in the art.

An “allele” as used herein refers to one of two or more alternative forms of a nucleotide sequence at a given position (locus) on a chromosome. Usually alleles are nucleotides present in a nucleotide sequence that makes up the coding sequence of a gene, but sometimes the term is used to refer to a nucleotide in a non-coding region of a gene. An individual's genotype for a given gene is the set of alleles it happens to possess. As noted herein, an individual can be heterozygous or homozygous for an allele of this invention.

Also as used herein, a “haplotype” is a set of SNPs on a single chromatid that are statistically associated. It is thought that these associations, and the identification of a few alleles of a haplotype block, can unambiguously identify all other polymorphic sites in its region. The term “haplotype” is also commonly used to describe the genetic constitution of individuals with respect to one member of a pair of allelic genes; sets of single alleles or closely linked genes that tend to be inherited together.

“Prevent,” “preventing” or “prevention,” it is intended to mean that the inventive methods eliminate or reduce the incidence or onset of the disorder, pathological state and/or disease condition or status in a subject as compared to that which would occur in the absence of the measure taken. Alternatively stated, the present methods slow, delay, control, or decrease the likelihood or probability of the disease or disorder in the subject, as compared to that which would occur in the absence of the measure taken.

“Treat,” “treating,” or “treatment” refers to any type of action or activity that imparts a modulating effect, which, for example, can be a beneficial effect, to a subject afflicted with a disorder, disease or illness, or at risk of developing a disorder, disease or illness, including improvement in the condition of the subject (e.g., in one or more symptoms), delay in the progression of the condition, prevention or delay of the onset of the disorder, and/or change in clinical parameters, disease or illness, etc., as would be well known in the art.

The present invention is more particularly described in the following examples that are intended as illustrative only since numerous modifications and variations therein will be apparent to those skilled in the art.

### EXAMPLES

### Example 1

### Diabetes Heart Study (DHS)

The study sample was comprised of 229 participants from the larger Diabetes Heart Study (DHS). Of these, 166 subjects from 89 families were of European American ancestry, and 63 subjects from 33 families were of African American descent. Methods for ascertainment and recruitment for the DHS have been described previously (Bowden et al. 2008). Briefly, siblings concordant for type 2 diabetes mellitus (T2DM) without renal insufficiency were recruited, as well as additional unaffected siblings. T2DM was defined as diabetes developing after 34 years of age and treated with insulin and/or other oral agents without a history of diabetic ketoacidosis. Potential participants were excluded if they showed evidence of nephropathy, defined as a serum creatinine concentration less than or equal to 1.3 mg/dl (women) or less than or equal to 1.5 mg/dl (men) after a minimum diabetes duration of 5 years.

The Institutional Review Board of Wake Forest University School of Medicine approved all study protocols, and all participants provided written informed consent. Participant examinations were conducted in the General Clinical Research Center of the Wake Forest University Baptist Medical Center and included interviews for medical history and health behaviors, anthropometric measures, resting blood pressure, fasting total cholesterol, low-density lipoprotein cholesterol (calculated), high-density lipoprotein cholesterol, triglycerides, hemoglobinA1c, fasting glucose, calcium, and inorganic phosphate.

### Fatty Acid Analysis

Serum was isolated from fasting whole blood samples and used for fatty acid analysis. A panel of 23 omega-3 and omega-6 fatty acids was quantified by gas chromatography with flame ionization detection (Table 2). Fatty acid methyl esters (FAME) were prepared (Metcalf et al. 1966) from duplicate serum samples (100 μl) in the presence of an internal standard (triheptadecanoin) as previously described in detail (Weaver et al, 2009). Individual fatty acids are expressed as percent of total fatty acids in a sample. For all samples, data peaks on chromatograms were examined to ensure quality and consistency of retention times for the identified fatty acids.

Genotyping and Tests for Association in the DHS subjects

Seven SNPs mapping to the FADS gene cluster (rs174537, rs102275, rs174546, rs174556, rs1535, rs174576, rs174579) were selected based on previous publications (Schaeffer et al. 2006, Tanaka et al. 2009, Allayee et al. 2008). Total genomic DNA was purified from whole blood samples obtained from subjects using the PUREGENE DNA isolation kit (Gentra, Inc., Minneapolis, Minn., USA). DNA concentration was quantified using standardized fluorometric readings on a Hoefer DyNA Quant 200 fluorometer (Hoefer Pharmacia Biotech Inc., San Francisco, Calif., USA). Each sample was diluted to a final concentration of 5 ng/μl. Genotypes were determined using a Sequenom MassARRAY SNP genotyping system (Sequenom Inc., San Diego, Calif., USA) (Bretow et al. 2001). This genotyping system uses single-base extension reactions to create allele-specific products that are separated and scored in a matrix-assisted laser desorption ionization/time of flight mass spectrometer. Primers for PCR amplification and extension reactions were designed using the Mass ARRAY Assay Design Software (Sequenom, Inc., San Francisco, Calif., USA). Of the samples, 3.5% were genotyped in duplicate with 100% reproducibility across the SNPs. Linkage disequilibrium (LD) was assessed by calculating D′ and r² within Haploview (Barrett et al, 2005) relying on a set of independent individuals in the data (a random selection of a single individual from each pedigree, N=33 and N=89 African American and white subjects, respectively) and haplotype blocks were defined according to the algorithm of Gabriel et al. (Gabriel et al. 2002).

Allele and genotype frequencies for each SNP were calculated from unrelated probands and tested for departure from Hardy-Weinberg equilibrium using a chi square goodness-of-fit test. Associations between SNPs and traits were performed using a series of variance components measured genotype models as implemented in SOLAR (Sequential Oligogenic Linkage Analysis Routines) (Almasy et al. 1998). Significance was evaluated using the likelihood ratio tests based on the correlation structure suggested by the familial relationships. The additive genetic model was the primary model of interest, however, for SNPs with less than 10 individuals homozygous for the minor allele a dominant model was analyzed. Effects for European Americans and African Americans were adjusted for age and sex. When necessary, phenotypes included in these analyses were transformed using the natural logarithm to approximate conditional normality and to reduce heterogeneity of residual phenotypic variance across SNP genotypes.

### Serum Fatty Acid Profiles Differ in Americans of African and European Descent

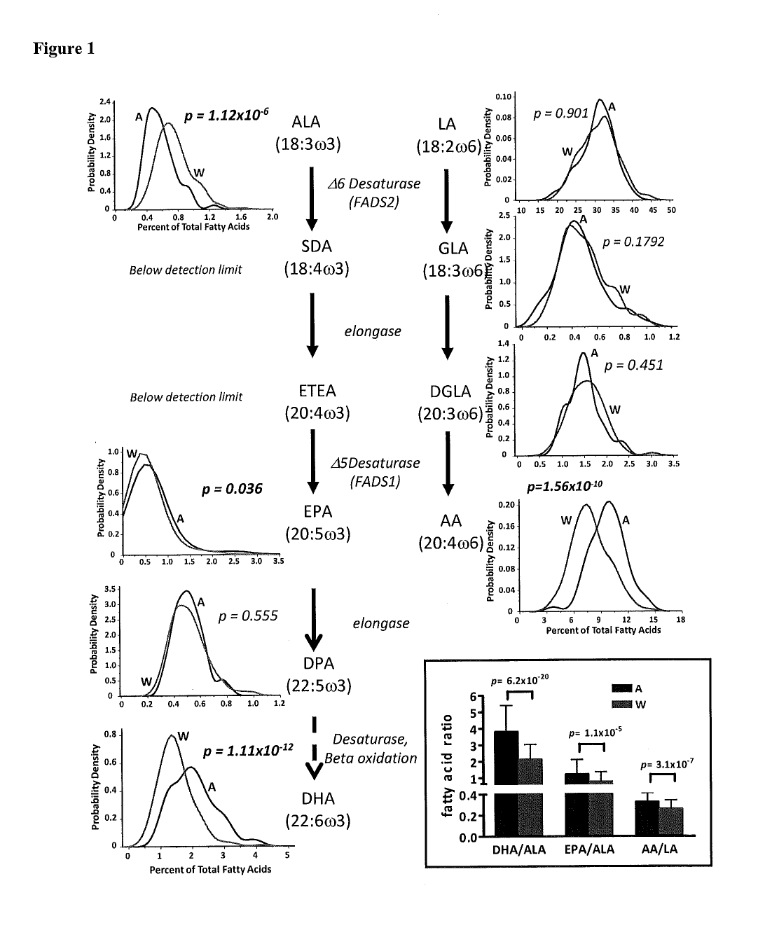

FIG. 1 shows the distribution of omega-3 and omega-6 PUFAs in sera of African American (N=63, 41.3% male, age=61.0±10.1) and white (N=166, 42.7% male, age=68.2±10.5) adults with metabolic syndrome/diabetes from the Diabetes Heart Study (DHS, (11,12)). There was a pronounced enhancement in levels of serum DHA and AA levels (p=1.11×10⁻¹² and 1.5×10⁻¹⁰, respectively) but lower levels of ALA (p=1.12×10⁻⁶) in African Americans compared to white subjects (FIG. 1). No differences in LA, GLA or DGLA (p=0.90, 0.18 and 0.45, respectively) were observed. Furthermore, the ratios of product to precursor (DHA/ALA and AA/LA) were markedly higher in the African American subjects (p=6.2×10⁻²⁰ and 3.1×10⁻⁷, respectively) suggesting an increased ability to convert MC-PUFAs to LC-PUFAs (FIG. 1, inset). Together, these data suggest that there is a more efficient conversion of precursor plant-based fatty acids to LC-PUFA products, AA and DHA, in African Americans versus whites. Alternatively, African Americans could consume higher quantities of preformed AA and DHA. However, for this to occur with DHA, there would have to be an increase in the consumption of oily fish by African Americans; a requisite not supported by studies measuring food frequencies in this population (13).

### FADS SNP Associations and Frequencies Differ Between Americans of African and European Decent

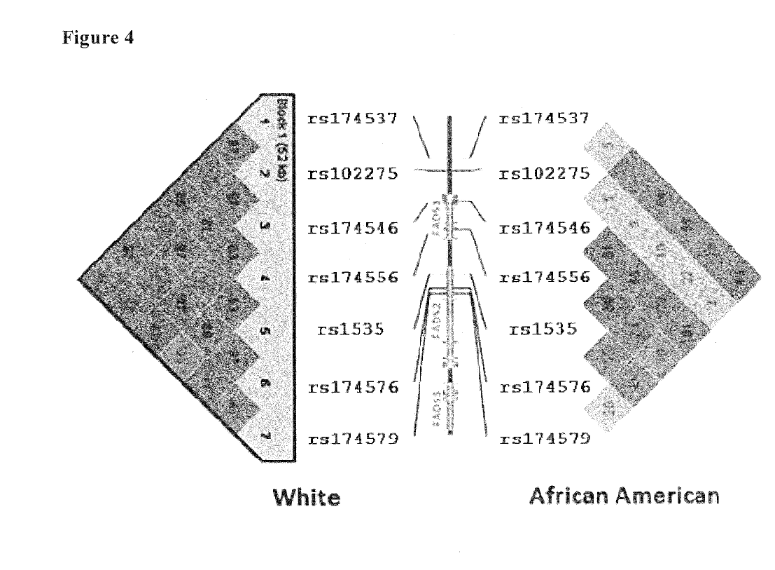

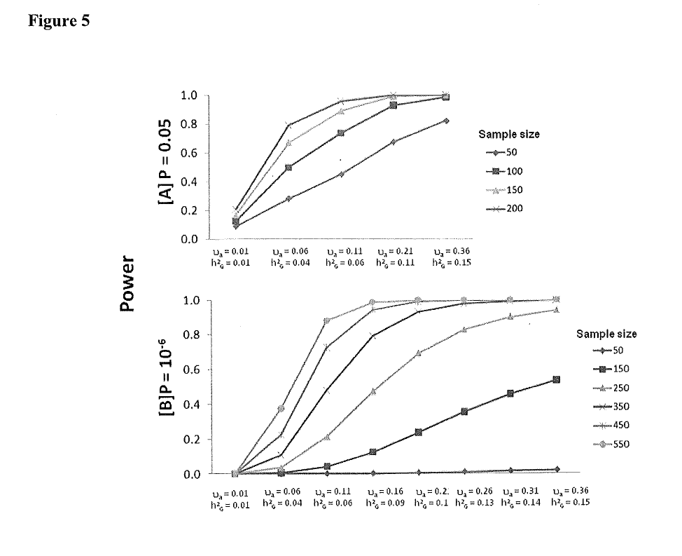

Tests for association were performed (12) with seven SNPs mapping to the FADS gene cluster in DHS subjects. The pattern of association observed in the white subjects was highly consistent with previous reports (7,8). There was high linkage disequilibrium (LD) in this region with a single LD block (53 Kb) that included all 7 SNPs in whites and included all of FADS1 and part of FADS2; no LD blocks were observed in the African Americans (FIG. 4, (12)). The strength of association (Table 2) for AA ranged from 9.4×10⁻⁴-5.9×10⁻⁸ in the whites; evidence for association was also observed for GLA (4.9×10⁻⁶-2.7×10⁻¹¹), DGLA (0.013-2.4×10⁻⁷), and EPA (3.9×10⁻³-5.6×10⁻⁴). While most of these associations were not replicated in the African American subjects (Table 2), we noted a striking difference in the allele frequencies across a majority of these SNPs in the FADS gene cluster between the African American and white individuals (Table 3). Allele frequencies of the minor allele were considerably lower in the African American subjects, with the complete absence of homozygotes across many of the SNPs resulting in lower power to replicate the findings in white subjects in African Americans (FIG. 5). More importantly, the allele associated with increased levels of LC-PUFAs was the allele that was typically higher in frequency in the African Americans (Table 2).

TABLE 2
Tests of association between serum PUFA levels and seven SNPs mapping to the FADS gene cluster in African American and white
subjects with metabolic syndrome from the DHS study. P-values <0.01 are color coded as per the insert to highlight strength of signal.

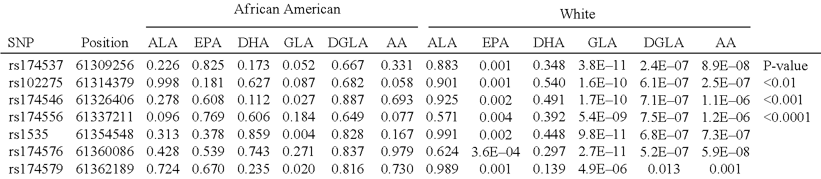

TABLE 3
Frequencies of the allelic variant associated with higher levels of LC-PUFAs at seven SNPs mapping to the FADS gene cluster in a
sample of subjects with Metabolic Syndrome with measured serum PUFA levels from the DHS study and founders from the large family-based
GeneSTAR study (12) illustrating increased frequencies in individuals of African ancestry in this region.

| | | Allele | | | | | | | | |
|---|---|---|---|---|---|---|---|---|---|---|
| | | associated | Metabolic | | GeneSTAR African | | | GeneSTAR White | | |
| SNP | | with | Syndrome Patients* | | American Families** | | | Families** | | |
| [ancestral/ | | increased | African | | | | No | | | No |
| derived allele] | Position | LC-PUFAS | American | White | All | MetSyn | MetSyn | All | MetSyn | MetSyn |
| rs174537 [T/G] | 61309256 | G | 0.89 | 0.65 | 0.91 | 0.91 | 0.93 | 0.67 | 0.67 | 0.65 |
| rs102275 [A/G] | 61314379 | A | 0.33 | 0.64 | 0.37 | 0.38 | 0.36 | 0.67 | 0.66 | 0.64 |
| rs174546 [T/C] | 61326406 | C | 0.91 | 0.65 | 0.92 | 0.91 | 0.93 | 0.67 | 0.67 | 0.65 |
| rs174556 [C/T] | 61337211 | C | 0.91 | 0.68 | 0.92 | 0.91 | 0.93 | 0.71 | 0.71 | 0.69 |
| rs1535 [G/A] | 61354548 | A | 0.83 | 0.64 | 0.86 | 0.86 | 0.87 | 0.67 | 0.66 | 0.65 |
| rs174576 [A/C] | 61360086 | C | 0.70 | 0.64 | 0.74 | 0.76 | 0.72 | 0.66 | 0.66 | 0.64 |
| rs174579 [C/T] | 61362189 | C | 0.92 | 0.79 | 0.95 | 0.95 | 0.94 | 0.79 | 0.78 | 0.79 |

*Frequency of derived allele based on 33 independent African American and 89 independent white subjects with metabolic syndrome from the DHS.
**Allele frequency estimates were obtained from in a defined set of all founders and stratified based on case/control status with regard to Metabolic Syndrome (141 case and 178 control African American founders and 200 case and 284 control white founders).

### Example 2

### Genetic Study of Atherosclerosis Risk (GeneSTAR)

The observed difference in allele frequency estimates between the African American and white subjects with metabolic syndrome was further verified in a large family-based sample; the Genetic Study of Atherosclerosis Risk (GeneSTAR, (12)).

Between 1983 and 2002, GeneSTAR enrolled 1087 asymptomatic, apparently healthy young siblings (<60 years of age) of patients with documented premature coronary artery disease (CAD) in a prospective study to investigate the mechanisms of incident premature CAD in high-risk families. All siblings had DNA isolated and stored at the time of enrollment. Among siblings enrolled at baseline, 99% (1075) were able to be followed for incident CAD. Siblings were identified from probands with documented CAD identified during hospitalization for acute myocardial infarction (N=121), coronary artery bypass surgery (N=192), percutaneous coronary intervention (N=200), angina with angiographic evidence of flow-limiting coronary stenosis (N=74), or sudden cardiac death (N=12). Their siblings were eligible if they were <60 years of age and had no known history of CAD. Siblings were also excluded if they had autoimmune disease, life-threatening co-morbidity (i.e. AIDS, cancer), or were receiving chronic glucocorticosteroid therapy as previously described (Blumenthal et al. 1996). The study was approved by the Johns Hopkins Medicine Institutional Review Board and all subjects gave informed consent.

All eligible siblings underwent a baseline comprehensive risk factor screening following a 12-hour overnight fast. A physical examination was performed, blood was taken for lipid and glucose levels, and a complete medical history was elicited. Cardiac risk factors were defined using thresholds and standard methods as previously described (Vaidya et al. 2007). Participants were followed at five-year intervals up to 25 years after baseline screening for incident CAD events. Metabolic syndrome was defined using the standard definition the Executive Summary of The Third Report of The National Cholesterol Education Program (NCEP) Expert Panel on Detection, Evaluation, And Treatment of High Blood Cholesterol in Adults (Adult Treatment Panel III) (Expert Panel on Detection, Evaluation, and Treatment of High Blood Cholesterol in Adults, 2001). An individual was classified as ever vs. never for the outcome of metabolic syndrome in the categorization of case vs. control status for the calculation of allele frequencies based on affection.

Allele frequency estimates were queried between the GeneSTAR subjects with and without metabolic syndrome within the founders of African American and white families (N=318 and 484, respectively). These data confirm that these differences in allele frequency are not a function of the metabolic syndrome phenotype, but rather a function of ethnicity (Table 2). The observed pattern of allele frequency distribution was consistent in direction across most SNPs evaluated: we observed an increase in the frequency of the allele that was associated with more efficient conversion to LC-PUFA within the African American group compared to the whites. For example at rs174537, the SNP with the strongest published evidence for association with LC-PUFAs, the frequency of the G allele is 91% in the African Americans and only 67% in the whites.

### Example 3

### Analysis of Human Genome Diversity Panel (HGDP) data

The two observations of: (i) increased levels of AA and DHA in the African American subjects (FIG. 1); and (ii) increased frequencies of alleles associated with higher levels of LC-PUFAs in African Americans (Table 2, above), suggests that there may have been a selective advantage resulting in higher frequencies of variant(s) leading to more efficient conversion of MC-PUFAs to LC-PUFAs in an environment where dietary access to LC-PUFAs was limited. Patterns of genetic variation were examined within the FADS locus in the Human Genome Diversity Panel (HGDP) using data generated by Pickrell et al. (14) that is publicly available through the HGDP genome browser (hgdp.uchicago.edu).

Genotypes from 1,043 samples from 52 populations in the Human Genome Diversity Panel (HGDP) available from the HGDP genome browser (hgdp.uchicago.edu) (Pickrell et al. 2009) were used to evaluate patterns of variation and natural selection around the FADS gene cluster (chr11:). Two haplotype-based tests were used to evaluate the degree of evidence for recent positive selection in the HGDP: the integrated Haplotype Score (iHS) (Voight et al. 2006), and the Cross Population Extended Haplotype Homozygosity (XP-EHH) (Sabeti et al. 2007). The iHS is useful for identifying partial selective sweeps by identifying common, advantageous alleles that reside on unusually long haplotypes due to little time for recombination to break up the haplotype containing the allele. However the iHS has reduced power to detect selection as the advantageous allele approaches fixation. Therefore, we also examined the XP-EHH statistic that includes a comparison to a reference population, making it more powerful for identifying completed or almost completed selective sweeps whereby the advantageous allele is almost fixed in one population but polymorphic in the human population as a whole. Data on both these statistics and allele frequencies were downloaded from the HGDP selection browser.

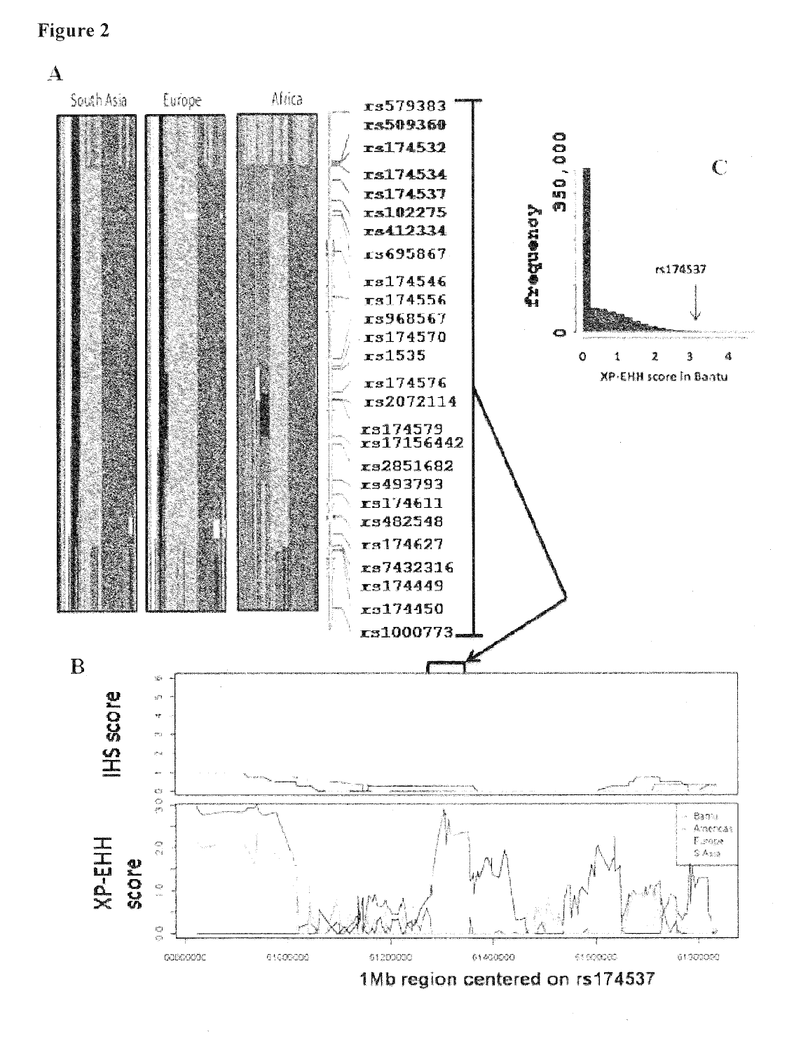

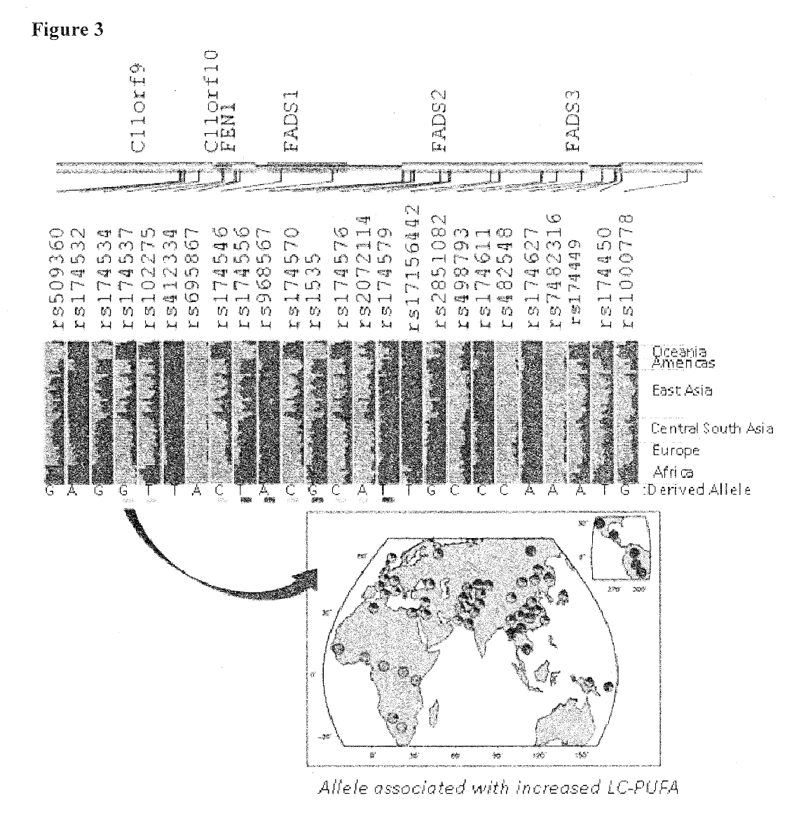

Haplotype diversity appears to be low within each of three continental regions (Europe, South Asia and Africa), with overall longer haplotypes observed in the non-African populations, consistent with population bottlenecks as humans migrated out of Africa (FIG. 2A) (15). The haplotype background in the African populations is unique, however, centered around 6 SNPs (rs509360, rs174532, rs174534, rs174537, rs102275 and rs412334) upstream of FADS1, the region with strongest association signals with LC-PUFAs and in strong LD with SNPs across all of FADS1 and most of FADS2 in European ancestry populations. FIG. 3 presents the frequency of the derived allele (in orange) for 23 SNPs in a 100 kb region in the 52 HGDP populations ordered by continental region. In many instances, the major allele within Africa corresponded to the putative derived allele, consistent with a possible selective sweep of advantageous alleles at this locus. Furthermore, alleles associated with increased levels of LC-PUFA are generally in higher frequency within Africa.

Most noteworthy is the variation at rs174537 where the derived allele (G) has swept to fixation within the African continent, but is at intermediate frequencies in the European and Asian continents and not observed in Central America (FIG. 3). This suggests the mutation likely arose prior to human migrations from Africa, and may have undergone positive selection within continental Africa. A selective advantage of the derived allele (G) is congruent with our observation that the strongest documented evidence for association with more efficient conversion to LC-PUFAs in this large LD block is with this same allele. To test this further, the XP-EHH and iHS scores were examined along a 1 Mb region on chromosome 11q13 (FIG. 2B) available through the HGDP selection browser. Evidence for recent positive selection is highest in the window containing rs174537 within the African continent relative to the European continent, with no evidence for selection within this window in either Europe or the Americas. The peak XP-EHH score is 2.78, which is in the 99.9^{th} percentile of the distribution of scores within Africa in the HGDP (FIG. 2C). Windows within the top 99th percentile of XP-EHH scores are strong candidates for having been subject to recent positive selection, and simulations suggest the target locus is likely to be within 50 kb of the signal (14). A selective sweep at or near rs174537 within the African continent is likely complete or nearly complete, as little evidence is found for selection within Africa based on the integrated Haplotype Score (iHS), which has limited power to detect selective sweeps where the advantageous allele has almost swept to fixation (FIG. 2B). Furthermore, the iHS does not appear to show evidence for a sweep in progress in populations outside of Africa (iHS=0.01, 1.1^{th} percentile of iHS in the European populations).

### Example 4

As critical components of neural tissue and immune signaling, sufficient amounts of DHA and AA would have been required for early hominids in Africa (5,9). Currently, there is much debate as to how early humans escaped the developmental vulnerability to obtain sufficient DHA and AA necessary to increase brain size (5,9,10,16) given that human metabolic studies to date indicate that only trace amounts of LC-PUFAs could have been synthesized from plant-derived sources (3). The present study suggests that there may have been one or more mutations in the FADS cluster, which occurred early in the development of humans, that markedly facilitated humankind's capacity to synthesize DHA and AA from plant sources. It is likely that the enhanced efficiency of this pathway has not been observed in human populations on a global level because isotope and dietary studies have primarily been conducted with subjects of European ancestry and many include confounding dietary sources of pre-formed LC-PUFAs. The current study has identified marked global differences in the allele frequencies of variants in the FADS gene cluster, especially at variants strongly associated with the efficiency of conversion of LA and ALA to AA and DHA, respectively.

The core message of Darwinian Medicine that much in biology can be understood in the light of evolution (17) found its earliest support from Haldane's observations of increased thalassemia in the Mediterranean imposed by selective pressures from malaria (18). More recent theories include the Hygiene (19,20) and Thrifty Gene (21) hypotheses, with strong backing from both advocates and critics. Nonetheless, the general premise is that genetic variations that were under selective pressure either due to the hunter-gatherer environment (e.g. the co-evolution of saprophytes and helminths in the Hygiene hypothesis (22)) or the advent of agriculture and pastoralism (e.g effects of famine in the Thrifty Gene hypothesis (23)) are now potentially maladaptive in modern day environments where human adaptation through cultural changes, has far outpaced adaptation through genetic changes. Under this model, given the high levels of omega-6 MC-PUFAs (15-20 g/day, principally LA) in western diets, a high capacity to convert MC-PUFAs to LC-PUFAs would consequentially promote increased production of inflammatory AA and products of AA, a trend that would correlate with allele frequencies at key loci. This is supported by the current study where circulating AA in African Americans is on average higher than that in individuals of European ancestry, under conditions where diet does not appear to be a factor, but where allele frequencies at the FADS gene cluster appear to be different.

Furthermore, multi-factorial diseases of chronic inflammation disproportionately affect African Americans in industrialized settings such as the United States (24), while simultaneously appear to be rare in continental Africans. Only 1-2% of Africans on the African continent have type-2 diabetes, whereas the incidence is 11-13% in people of African descent in industrialized nations consuming a western diet (25,26). No doubt a complex interplay of genes and environment are contributing to these differences, one of which may be variants found in FADS that confer increased risk as populations moved from traditional to western diets.

The present observations may also have important ramifications in the prevention and treatment of childhood malnutrition globally due to both food scarcity and the consumption of staple diets such as refined maize flour. Corn-based maize and other commonly used staples, while an attractive vehicle to feed children, contains an imbalance of macronutrients (˜90% carbohydrates, 6-8% protein, and 2-5% fat). Moreover, the fat composition of the staple diets or therapeutic foods (designed to prevent or treat malnutrition) comprise PUFAs that contain almost exclusively LA and ALA and no LC-PUFAs. Given the dramatic differences in allele frequencies noted in geographic regions with malnutrition, these studies suggest that the important and necessary conversion of plant-based PUFAs to LC-PUFAs would be more efficient in children living in regions of Africa, for example, compared to children of different biogeographical ancestries living in Central or South America.

Taken together, the current study proposes a novel biological mechanism by which our early ancestors may have developed an increased capacity to synthesize LC-PUFAs, overcoming the limited dietary availability of AA and DHA, both essential for increased encephalization and immune system development. Additionally, these observations may help us better understand gene-nutrient interactions with regard to PUFA biosynthesis and metabolism and the potential role that such genetic differences could play in health disparities or the incidence of chronic inflammatory diseases. Finally this new understanding of geographic differences in allele frequencies could impact the development of effective staple foods and fatty acid-based dietary supplements in the prevention of malnutrition in different populations around the world.

### REFERENCES

1. S. M. Innis. Dietary omega 3 fatty acids and the developing brain. Brain Res. 1237, 35-43 (2008).
2. G. M. Cole, Q. L. Ma, S. A. Frautschy. Omega-3 fatty acids and dementia. Prostaglandin Leukotr. Essent. Fatty Acids 81, 213-221(2008).
3. J. T. Brenna, N. Salem, Jr., A. J. Sinclair, S. C. Cunnane, Int. Soc. for the Study of Fatty Acids and Lipids. α-Linolenic acid supplementation and conversion to n-3 long-chain polyunsaturated fatty acids in humans. Prostaglandin Leukotr. Essent. Fatty Acids 80, 85-91 (2002).
4. S. C. Cunnane, M. Plourde, K. Stewart, M. A. Crawford. Docosahexaenoic acid and shore-based diets in hominin encephalization: A rebuttal. Am. J. Hum. Biol. 19, 578-581 (2007).
5. L. Cordain, B. A. Watkins, N. J. Mann. Fatty acid composition and energy density of foods available to African hominids. Evolutionary implications for human brain development. World RevN utr. Diet. 90, 144-161 (2001).
6. A. Marquardt, H. Stohr, K. White, B. H. F. Weber. cDNA cloning, genomic structure, and chromosomal localization of three members of the human fatty acid desaturase family. Genomics 66, 175-183 (2000).
7. E. Lattka, T. Illig, J. Heinrich, B. Koletzko. FADS gene cluster polymorphisms: Important modulators of fatty acid levels and their impact on atopic diseases. J. Nutrigent. Nutrigenomics 2, 119-128 (2009).
8. Tanaka, T., Shen, J., Abecasis, G. R., Kisialiou, A., Ordovas, J. M. et al. Genome-wide association study of plasma polyunsaturated fatty acids in the InCHIANTI study. PLoS Genet. 5, e1000338 (2009), doi:10.1371/journal.pgen.1000338.
9. C. L. Broadhurst, Y. Wang, M. A. Crawford, S. C. Cunnane, J. E. Parkington et al. Brain-specific lipids from marine, lacustrine, or terrestrial food resources: potential impact on early African Homo sapiens. Comp. Biochem. Physiol. Part B: Biochem. Mol. Biol. 131, 653-673 (2002).
10. B. Carlson, J. D. Kingston, Docosahexaenoic acid biosynthesis and dietary contingency: Encephalization without aquatic constraint. Am. J. Hum. Biol. 19, 585-588 (2007).
11. D. W. Bowden, A. B. Lehtinen, J. T. Ziegler, M. E. Rudock, J. Xu et al. Genetic epidemiology of subclinical cardiovascular disease in the Diabetes Heart Study. Ann. Hum. Genet. 72, 598-610 (2008).
12. Information on Materials and Methods and Supplemental Materials is available on Science Online.
13. K. M. Gans, G. J. Burkholder, P. M. Risica, T. M. Lasater. Baseline fat-related dietary behaviors of white, Hispanic, and black participants in a cholesterol screening and education project in New England. J. Am. Diet. Assoc. 103, 699-706 (2003).
14. J. K. Pickrell, G. Coop, J. Novembre, S. Kudaravalli, J. Z. Li et al. Signals of recent positive selection in a worldwide sample of human populations. Genome Res. 19, 826-837 (2009).
15. M. C. Campbell, S. A. Tishkoff. African genetic diversity: Implications for human demographic history, modern human origins, and complex disease mapping. Ann. Rev. Genom. Hum. Genet. 9, 403-433 (2008).
16. M. A. Crawford, M. Bloom, C. L. Broadhurst, W. F. Schmidt, S. C. Cunnane et al. Evidence for the unique function of docosahexaenoic acid during the evolution of the modern hominid brain. Lipids 34, S39-S47 (1999).
17. T. Dobzhansky. Biology, molecular and organismic. Am. Zool. 4, 443-452 (1964).
18. J. B. S. Haldane. The rate of mutation of human genes. Proc. Eighth Int. Congr. Genet. Hered. 35, 267-273 (1949).
19. D. P. Strachan. Hay fever, hygiene and household size. BMJ 299, 1259-1260 (1989).
20. E. von Mutius, F. D. Martinez, C. Fritzsch, T. Nicolai, G. Roell et al. Prevalence of asthma and atopy in two areas of West and East Germany. Am. J. Respir. Crit. Care Med. 149, 358-364 (1994).
21. J. V. Neel. Diabetes mellitus: a “thrifty” genotype rendered detrimental by “progress”? Am. J. Hum. Genet. 14, 352-353 (1962).
22. M. Sironi, M. Clerici. The hygiene hypothesis: An evolutionary perspective. Microbes Infection ePub ahead of print (2010), doi:10.1016/j,micinf.2010.02.002.
23. A. M. Prentice. Starvation in humans: Evolutionary background and contemporary implications. Mech. Ageing Devel. 126, 976-981 (2005).
24. American Heart Association, American Heart Association. Heart Disease and Stroke Statistics-2008 Update. www.americanheart.org/downloadable/heart/1200082005246HS_Stats %202008.final.pdf, accessed: Nov. 25, 2009.

25. World Health Organization, Diabetes Programme: Facts and Figures. www.who.int/diabetes/facts/en/index.html, accessed: Nov. 25, 2009.

26. American Diabetes Association, Diabetes Statistics-2007. www.diabetes.org/diabetes-basics/diabetes-statistics/, accessed: Nov. 25, 2009.

27. World Food Programme. Hunger. www.wfp.org/hunger/stats, accessed:3-24-2010.

28, D. F. Conrad, M. Jakobsson, G. Coop, X. Wen, J. D. Wall et al. A worldwide survey of haplotype variation and linkage disequilibrium in the human genome. Nat. Genet. 38, 1251-1260 (2006).
29. B. F. Voight, S. Kudaravalli, X. Wen, J. K. Pritchard. A map of recent positive selection in the human genome. PLoS Biol. 4, e72. doi:10.1371/journal.pbio.0040072-(2006).
30. P. C. Sabeti, P. Varilly, B. Fry, J. Lohmueller, E. Hostetter et al. Genome-wide detection and characterization of positive selection in human populations. Nature 449, 913-918 (2007).
1. D. W. Bowden, A. B. Lehtinen, J. T. Ziegler, M. E. Rudock, J. Xu et al. Genetic epidemiology of subclinical cardiovascular disease in the Diabetes Heart Study. Ann. Hum. Genet. 72, 598-610 (2008).
2. R. S. Blumenthal, D. M. Becker, T. F. Moy, J. Coresh, L. B. Wilder et al. Exercise thallium tomography predicts future clinically manifest coronary heart disease in a high-risk asymptomatic population. Circulation 93, 915-923 (1996).
3. D. Vaidya, L. R. Yanek, T. F. Moy, T. A. Pearson, L. C. Becker et al. Incidence of coronary artery disease in siblings of patients with premature coronary artery disease: 10 years of follow-up. Am. J. Cardiol. 100, 1410-1415 (2007).
4. Expert Panel on Detection, Evaluation, and Treatment of High Blood Cholesterol in Adults (Adult Treatment Panel III). JAMA 285, 2486-2497 (2001).
5. L. D. Metcalfe, A. A. Schmitz, J. R. Pelka. Rapid preparation of fatty acid esters from lipids for gas chromatographic analysis. Anal. Chem. 38, 514-515 (1966).
6. K. L. Weaver, P. Ivester, M. C. Seeds, L. D. Case, J. Arm et al. Effect of dietary fatty acids on inflammatory gene expression in healthy humans. J. Biol. Chem. 284, 15400-15407 (2009).
7. L. Schaeffer, H. Gohlke, M. Muller, I. M. Heid, L. J. Palmer et al. Common genetic variants of the FADS1 FADS2 gene cluster and their reconstructed haplotypes are associated with the fatty acid composition in phospholipids. Hum. Mol. Genet. 15, 1745-1756 (2006).
8. Tanaka, T., Shen, J., Abecasis, G. R., Kisialiou, A., Ordovas, J. M. et al. Genome-wide association study of plasma polyunsaturated fatty acids in the InCHIANTI study. PLoS Genet. 5, e1000338 (2009), doi:10.1371/journal.pgen.1000338.
9. H. Allayee, A. Baylin, J. Hartiala, H. Wijesuriya, M. Mehrabian et al. Nutrigenetic association of the 5-lipoxygenase gene with myocardial infarction. Am. J. Clin. Nutr, 88, 934-940 (2008).
10. K. H. Buetow, M. Edmonson, R. MacDonald, R. Clifford, P. Yip et al. High-throughput development and characterization of a genomewide collection of gene-based single nucleotide polymorphism markers by chip-based matrix-assisted laser desorption/ionization time-of-flight mass spectrometry. Proc. Natl. Acad. Sci. USA 98, 581-584 (2001).
11. J. C. Barrett, B. Fry, J. Mailer, M. J. Daly. Haploview: analysis and visualization of LD and haplotype maps. Bioinformatics 21, 263-265 (1-15-2005).
12. S. B. Gabriel, S. F. Schaffner, H. Nguyen, J. M. Moore, J. Roy et al. The structure of haplotype blocks in the human genome. Science 296, 2225-2229 (2002).
13. L. Almasy, J. Blangero, Multipoint quantitative-trait linkage analysis in general pedigrees. Am. J. Hum. Genet. 62, 1198-1211 (1998).
14. J. K. Pickrell, G. Coop, J. Novembre, S. Kudaravalli, J. Z. Li et al. Signals of recent positive selection in a worldwide sample of human populations. Genome Res. 19, 826-837 (2009).
15. B. F. Voight, S. Kudaravalli, X. Wen, J. K. Pritchard. A map of recent positive selection in the human genome. PLoS Biol. 4, e72. doi:10.1371/journal.pbio.0040072 (2006).
16. P. C. Sabeti, P. Varilly, B. Fry, J. Lohmueller, E. Hostetter et al. Genome-wide detection and characterization of positive selection in human populations. Nature 449, 913-918 (2007).

That which is claimed is:

1. A method of identifying a subject having an increased ability to convert medium chain-polyunsaturated fatty acids (MC-PUFAs) to long chain polyunsaturated fatty acids (LC-PUFAs), comprising:
detecting in the subject one or more than one genetic marker in chromosome 11q12-13, between build 37.1 position 61548559 and build 37.1 position 61560261, correlated with an increased ability to convert MC-PUFAs to LC-PUFAs.

3. A method of identifying a subject having a decreased ability to convert medium chain-polyunsaturated fatty acids (MC-PUFAs) to long chain polyunsaturated fatty acids (LC-PUFAs) comprising:
detecting in the subject the presence of one or more than one genetic marker in chromosome 11q12-13, between build 37.1 position 61548559 and build 37.1 position 61560261, correlated with a decreased ability to convert MC-PUFAs to LC-PUFAs.

3. A method of screening a subject for an increased ability to convert medium chain-polyunsaturated fatty acids (MC-PUFAs) to long chain polyunsaturated fatty acids (LC-PUFAs) comprising:
detecting the presence or absence of one or more than one genetic marker in chromosome 11q12-13, between build 37.1 position 61548559 and build 37.1 position 61560261, correlated with an increased ability to convert MC-PUFAs to LC-PUFAs, wherein the presence of said marker indicates that the subject has an increased ability to convert MC-PUFAs to LC-PUFAs.

4. A method of screening a subject for a decreased ability to convert medium chain-polyunsaturated fatty acids (MC-PUFAs) to long chain polyunsaturated fatty acids (LC-PUFAs) comprising:
detecting the presence or absence of one or more than one genetic marker in chromosome 11q12-13, between build 37.1 position 61548559 and build 37.1 position 61560261, correlated with a decreased ability to convert MC-PUFAs to LC-PUFAs, wherein the presence of said marker indicates that the subject has a decreased ability to convert MC-PUFAs to LC-PUFAs.

5. A method of correlating a genetic marker with an increased ability to convert medium chain-polyunsaturated fatty acids (MC-PUFAs) to long chain polyunsaturated fatty acids (LC-PUFAs), comprising:
a) detecting in a population of subjects with an increased ability to convert MC-PUFAs to LC-PUFAs the presence of one or more genetic markers in chromosome 11q12-13, between build 37.1 position 61548559 and build 37.1 position 61560261; and
b) correlating the presence of the one or more genetic markers of step (a) with an increased ability to convert MC-PUFA to LC-PUFA.

6. A method of correlating a genetic marker with a decreased ability to convert medium chain-polyunsaturated fatty acids (MC-PUFAs) to long chain polyunsaturated fatty acids (LC-PUFAs), comprising:
a) detecting in a population of subjects with a decreased ability to convert MC-PUFAs to LC-PUFAs the presence of one or more genetic markers in chromosome 11q12-13, between build 37.1 position 61548559 and build 37.1 position 61560261; and
b) correlating the presence of the one or more genetic markers of step (a) with a decreased ability to convert MC-PUFA to LC-PUFA.

7. A method of identifying a subject for whom a defined dietary regimen would be effective, comprising:
detecting in the subject one or more than one genetic marker in chromosome 11q12-13, between build 37.1 position 61548559 and build 37.1 position 61560261, correlated with an effective defined dietary regimen for individuals having said one or more genetic markers.
